(19) United States
(12) Patent Application Publication
(10) Pub. No.: US 2018/0030860 A1
(43) Pub. Date: Feb. 1, 2018

(54) DEVICE FOR THE TRANSMISSION OF KINETIC ENERGY FROM A WORKING FLUID TO A RECEIVING FLUID

(71) Applicants: UNIVERSITE AIX MARSEILLE, Marseille Cedex 07 (FR); CENTRE NATIONAL DE LA RECHERCHE SCIENTIFIQUE (CNRS), Paris Cedex 16 (FR)

(72) Inventors: Stéphane LAUNAY, Gréasque (FR); Kifah SARRAF, Anfeh (LB)

(21) Appl. No.: 15/550,398

(22) PCT Filed: Feb. 12, 2016
(86) PCT No.: PCT/EP2016/053062

§ 371 Date: Aug. 11, 2017

(30) Foreign Application Priority Data
Feb. 13, 2015 (FR) 1551222

(51) Int. Cl. F01K 27/00; F02K 9/42; F02K 9/50

(52) U.S. Cl. CPC F01K 27/005; F02K 9/50; F02K 9/425; F01K 3/004

(57) ABSTRACT

A system for exchanging heat from a working fluid to a receiving fluid, which includes: a device for transmitting kinetic energy from a working fluid to a receiving fluid, the device including: a circulator suitable for circulating the receiving fluid; a turbine suitable for being driven by the circulation of the working fluid; and a shaft coupling the turbine to the circulator; a heat transfer system for transferring heat from the working fluid by heat transfer from the receiving fluid; and a mixing system for mixing the receiving fluid and the heated working fluid.

### TECHNICAL FIELD OF THE INVENTION

The invention relates to a device for transmitting kinetic energy from a working fluid to a receiving fluid and to a system for exchanging heat from a working fluid to a receiving fluid comprising such a device. The invention finds application more particularly in the field of heat exchange between two fluids.

### PRIOR ART

The production of domestic hot water (DHW) represents a significant part of primary energy consumption, of the order of 5% for France for example.

In a domestic hot water storage cylinder, the water is at a temperature of around 60° C. in order to avoid the development of bacteria, of legionella type.

However, the water at the outlet of the cylinder intended to be consumed by the user (whether it is a person or a domestic appliance) must have a temperature not exceeding, generally, 45° C. in order to avoid risks of burning. Thus, before the drawing point, and thus before even the outlet valves and fittings of the DHW storage cylinder, a mixing between the hot water stored at 60° C. and cold water is necessary in order to bring the temperature of the water to be distributed to a temperature of around 45° C. This mixing is generally carried out at the level of a thermostatic mixer. However, on account of important temperature differences between the hot water and the cold water, a considerable degradation of the quality of heat energy is observed. This degradation increases with the difference in temperature between the hot water and the cold water, entailing an increase in the consumption of hot water for a set flow rate and temperature. The energy performances of certain domestic hot water production systems are sensitive to the temperature level of the water contained in such systems, for example for solar or heat pump type systems.

It is thus preferable not to mix cold water with hot water contained in the cylinder, but rather cold water preheated with hot water contained in the cylinder with a view to limiting the consumption of hot water at the level of the mixer.

FIG. 1 shows a system in which the preheating of cold water 1 (water that enters the network) takes place by means of a heat exchanger with coil 2 immersed in the storage tank 3 containing domestic hot water at around 60° C., The preheated water 11 at the outlet of the coil is mixed with the hot water 4 at the outlet of the tank at the level of a thermostatic valve 5. Water for drawing 6 at the outlet of the thermostatic valve is then ready to be withdrawn by a user. The temperature of the preheated water 11 at the outlet of the coil varies as a function of the energy state of the water stored in the tank and the drawing flow rate. The coil exchanger has the drawback of having low capacity to transfer high thermal power levels. For example, to preheat a flow rate of water of 10 L/min from 15° C. to 35° C., a thermal power of 14 KW is required. For such a level of thermal power, it is preferable to use plate exchangers such as that shown in FIG. 2.

In the assembly of FIG. 2, the preheating of cold water 1 occurs by means of a plate exchanger 21 in which both cold water 1 and hot water 4 coming from the storage tank 3 circulate. Heat transfer takes place at the level of the plate exchanger 21 between hot water 4 and cold water 1. Thus, at the outlet of the plate exchanger, cold water 1 is preheated 11. The assembly of FIG. 2 shows a first thermostatic valve 5 and a second thermostatic valve 51. The second thermostatic valve 51 makes it possible to add a level of security to the system in order to avoid that the user at the end of the line does not receive water that is too hot if the heat recovery system is very efficient. In fact, if the heat recovery system, plate exchanger, is too efficient this leads to the temperature of the preheated water 11 at the outlet of the plate exchanger being higher than the set point temperature at the level of the first thermostatic valve 5. However, one disadvantage of such a system is that it requires the presence of an electrical circulator with a view to circulating the flows of liquid in the exchanger, which induces an additional electrical consumption. Moreover, such a type of assembly requires a regulation of the circulator so that it only operates at the moment where there is need for heat transfer, that is to say at the moment of drawing. Since drawings are very intermittent, it is thus necessary to integrate a measurement and an appropriate metrology.

### DESCRIPTION OF THE INVENTION

The invention aims to remedy all or part of the drawbacks of the prior art identified above, and notably to propose means enabling the preheating of cold water for cooling before drawing domestic hot water, these means having to induce a minimum energy consumption and notably less than that of devices that already exist.

In order to do so, one aspect of the invention relates to a device for transmitting kinetic energy from a working fluid to a receiving fluid, said device comprising:
a circulator suitable for circulating the receiving fluid;
a turbine suitable for being driven by the circulation of the working fluid; and
a shaft coupling the turbine to the circulator.

This device is passive because the receiving fluid is set in motion by the circulator without any external energy consumption other than the energy transmitted by the working fluid going through the turbine.

For example, the working fluid may be a fluid coming from the water network.

When the connection of the turbine to the water network is open, the working fluid drives in movement the turbine by going through it and the gravitational potential energy, or kinetic energy, of the working fluid is transformed into mechanical potential energy, via the mechanical shaft, for setting in motion the receiving fluid by means of the circulator coupled to the turbine. Thus, any type of electrical conversion of energy is avoided. The flow rate of the circulator automatically adapts to the drawing flow rate of the working fluid. Thus, this device does not require an electrical command, which simplifies the putting in place of the control-command of such a device.

In a preferential manner, the turbine comprises a first axis of rotation, the circulator comprises a second axis of rotation co-linear with the first axis of rotation, the shaft coupling the first axis of rotation to the second axis of rotation. In the field of domestic hot water production, the working fluid is generally water coming from the water network, at a low pressure of around 4 bars. The co-linearity between the first axis and the second axis makes it possible to transfer all of the energy from the turbine to the circulator to drive the circulation of the receiving fluid, without using U-joints to linearize the relation between the two axes of rotation, if they were not co-linear which induces energy losses between the turbine and the circulator.

In a preferential manner, the turbine is a propeller turbine. It may for example be a bulb, Straflo, Pelton or Francis type turbine, or in particular a Kaplan type turbine.

The Kaplan turbine is known for its use for producing electrical energy from hydraulic energy. In the present invention, the inventor has found that for certain types of application, to be specific the production of domestic hot water, it is necessary to place two fluids in circulation simultaneously. Instead of using two circulators as is done normally, which implies a specific and reactive control command, in the invention the two fluids are coupled through the turbine and the circulator to ensure a simultaneous movement of the working fluid having a kinetic force that is going to make it possible to transfer its energy instantaneously to the receiving fluid. This makes it possible to simplify the device in that there is no longer need for external command, everything taking place in a direct manner, i.e. without need for energy intervention external to that of the fluids. This is thus known as a passive system.

Furthermore, in this application, the Kaplan type turbine proves to be the most appropriate for low pressure drops.

A Kaplan type turbine is a propulsion turbine comprising a propeller, a distributor and an aspirator. The propeller is the part turning on the shaft which converts the energy of the working fluid going through the turbine into mechanical energy transmitted to the mechanical shaft for driving the receiving fluid going through the circulator coupled to the mechanical shaft and thus setting in motion the receiving fluid. The distributor is a ring of moveable profiled fins that direct the working fluid and controls its setting in rotation (tangential component of the velocity of the fluid) depending on its degree of opening. The distributor may also serve as flow rate regulation valve. It is the role of the distributor that uses the pressure generated by the manometric head (linked to the head of the fluid, which corresponds to the pressure difference of the liquid crossing through the turbine, expressed in metres of water column) to force the working fluid to go through its fins oriented in such a way as to generate a vortex. The pressure energy (or head) is thus transformed into tangential velocity. It is advisable to clearly differentiate two components in the velocity of the working fluid going through the propeller: the axial velocity and the tangential velocity. The axial velocity is the velocity in the direction parallel to the axis of the turbine. The flow rate of the system is given by this axial velocity multiplied by the section swept by the propeller, also called turbine section. The tangential velocity is the velocity of rotation of the vortex caused by the distributor (sometimes combined with a volute). Unlike the axial velocity, the tangential velocity may be totally harnessed (stopped) without the flow of the working fluid being interrupted. A totally captured tangential velocity thus becomes zero and leads to a general flow that is uniquely axial. The distributor converts the hydraulic energy into velocity of rotation of the vortex. The quality of harnessing the energy of tangential velocity is optimum when the flow at the outlet of the propeller has lost all of its tangential component (i.e. there is no longer any vortex). The hydraulic energy is transformed into tangential velocity of which the totality of the energy may be captured and the flow rate generates an axial velocity of which it is possible to extract only around 60% of the energy. The aspirator or diffuser is a divergent cone generating a drop in pressure by using the remaining velocity at the propeller outlet. The hydraulic power Ph in watts of a turbine is expressed by Ph(gross)=Q(m³/s)×H(m)×ρ(kg/m³)×g(m/s²), with:

(Equation 1)
H the difference in available head in metres between the surfaces of the basin upstream of the turbine and downstream of the turbine (equivalent to the energy losses in the component);
Q the volumetric flow rate (turbined flow rate) passing through the system in m³/sec;
ρ the density of water in kg/m³;
g the acceleration due to gravity in m/s².

In going through the propeller of the turbine, the fluid is going to transmit its energy to the propeller shaft thanks to the drop in pressure generated by the blades. This energy lost by the fluid will result in a loss of velocity and pressure between the upstream and downstream of the propeller. For a given operating flow rate, it will thus be necessary to have a pressure upstream of the propeller greater than the pressure absorbed by the propeller. It is thus necessary that the net drop in the operating flow rate is sufficient to compensate the pressure differential generated by the propeller.

In a preferential manner, the circulator is of centrifugal force vane type. A circulator has the role of converting mechanical energy into hydraulic energy. A circulator of centrifugal type is particularly suitable for such a role. The liquid enters into an impeller of the circulator, said impeller being actuated by the turbine, axially via the suction flange and the suction neck is deviated by vanes of the impeller of the circulator in a radial movement. The centrifugal forces affect each particle of the liquid causing an increase in the velocity and the pressure when the liquid flows through the zone of the vanes. When the fluid comes out of the impeller, it is collected in the volute.

The coupling between a Kaplan type turbine and a circulator of centrifugal force vane type makes it possible to minimise pressure drops at the level of the turbine for a given driven flow rate of liquid, and thus to limit head losses and increase the energy efficiency of such a device.

The invention also relates to a system for the production (recovery) of domestic hot water, said system comprising:
a device for transmitting kinetic energy from a working fluid to a receiving fluid according to one of the embodiments described previously;
a means for transferring heat from the working fluid by heat transfer to the receiving fluid;
a means for mixing the receiving fluid and the working fluid.

For the production (recovery) of domestic hot water, this system enables mixing between a receiving fluid: hot water stored at a high temperature, for example 60° C.; and a heated working fluid: cold water coming from the network heated by the means for transferring heat. At the outlet of the mixing means, water ready for domestic use is thus obtained. The result is that the more the working fluid is heated, the less hot water stored at a high temperature is consumed. The system thus makes it possible to reduce the consumption of hot water stored at a high temperature.

Thus, when domestic hot water is drawn at the outlet of the mixing means, the water from the network, here the working fluid, drives in movement the turbine by flowing through the turbine. The induced setting in rotation of the turbine activates simultaneously the setting in motion of the receiving fluid which enables the heating of the working fluid by heat transfer within the means for transferring heat. For example, if the means for transferring heat is a plate exchanger, the receiving fluid transmits its heat to the working fluid by the circulation of the receiving fluid and the working fluid within the plate exchanger.

Apart from the main characteristics that have been mentioned in the preceding paragraph, the system according to the invention may have one or more additional characteristics among the following, considered individually or according to any technically possible combinations thereof:
the system comprises a first pipe suitable for the circulation of the working fluid and connected to the turbine; and a second pipe suitable for circulating the receiving fluid and connected to the circulator;
the means for mixing comprises a first inlet connected to a means for storing the receiving fluid and a second inlet connected to the means for transferring heat from the working fluid;
the turbine comprises an inlet intended to be connected to the drinking water network. The drinking water network generally has a considerable potential energy;
the system comprises a second means for mixing the fluid coming out of the first means for mixing and the heated working fluid;
the circulator comprises an outlet intended to be connected to a hot water storage tank;
the means for mixing is a thermostatic valve;
the means for transferring heat is a plate exchanger.

The system preferentially comprises a command means making it possible to modify the orientation of the blades of the turbine as a function of the characteristics of the working fluid.

### BRIEF DESCRIPTION OF THE FIGURES

Other characteristics and advantages of the invention will become clear on reading the description that follows, with reference to the appended figures, which illustrate:

FIG. 1, a view of a system for the production of domestic hot water according to a first prior art;

FIG. 2, a view of a system for the production of domestic hot water according to a second prior art;

FIG. 3, a view of a system for the production of domestic hot water according to one embodiment of the invention;

FIG. 4, a view of a system for the production of domestic hot water according to another embodiment of the invention.

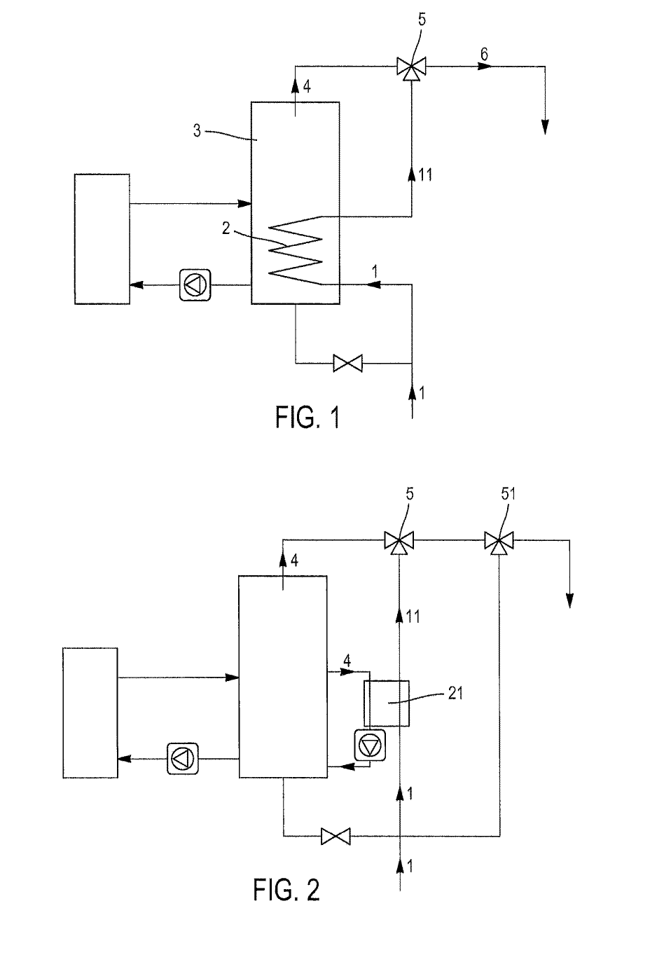

For greater clarity, identical or similar elements are marked by identical reference signs in all of the figures.

### DETAILED DESCRIPTION OF AN EMBODIMENT

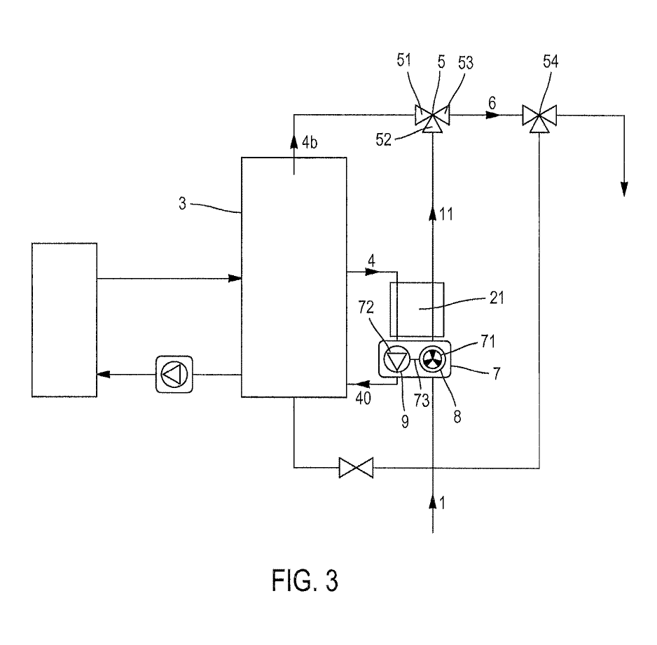

In FIG. 3 is illustrated a system for the production of domestic hot water comprising a device 7 for setting in motion a receiving fluid 4. The device 7 comprises in this exemplary embodiment a first pipe 8 connected to a Kaplan type propeller turbine 71, a second pipe 9 connected to a circulator 72 of centrifugal force vane type and a mechanical shaft 73 mechanically coupling the turbine to the circulator. Thus, when the turbine enters into movement, it drives the circulator. The propeller turbine, in this exemplary embodiment, is connected to the first pipe 8. The circulator, in this exemplary embodiment, is connected to the second pipe 9. Thus, the working fluid circulates in the first pipe 8 and in the turbine 71 and the receiving fluid circulates in the second pipe 9 and in the circulator.

The propeller turbine 71 is connected at the inlet to the circuit of cold water coming from the drinking water network. The working fluid 1 that can drive the turbine is, in this example, cold water.

The circulator 72 is connected at the outlet to a hot water storage tank 3, for example a hot water cylinder.

The receiving fluid 4 going through the circulator is, in this example, hot water coming from the cylinder.

When domestic hot water is drawn, requiring cooling of the hot water 4 contained in the storage tank 3, the working fluid 1, here cold water, is going to flow through the turbine part 71 of the device 7. The flow of the working fluid 1 through the turbine rotationally drives the turbine 71 on account of the sufficient pressure of the water network. Due to the mechanical coupling by means of the mechanical shaft 73, the gravitational potential energy or kinetic energy of the cold water that goes through the turbine is transformed into mechanical energy at the level of the device 7 and the receiving fluid 4 going through the circulator is driven in movement when the turbine is driven in rotation by the circulation of the working fluid 1.

The receiving fluid 4 goes through a means 21 for transferring heat from the working fluid, here plate exchanger 21, then the circulator 72 when it is driven in movement. At the outlet of the circulator, this fluid will be called receiving fluid 4a. The working fluid, during drawing, passes through the turbine 71 then the means 21 for transferring heat. The heat of the receiving fluid 4 is transmitted to the working fluid 1 within the plate exchanger. At the outlet of the circulator 72, the receiving fluid 4a is sent back to the storage cylinder 3. The preheated working fluid 11 is sent to the inlet of a means for mixing, of thermostatic valve type for example, in which it is mixed with the fluid coming out of the storage cylinder 3, hereafter called hot water 4b, in order to obtain at the outlet of the means for mixing a third fluid 6 (mixing of the fluid 11 and the fluid 4b) at a temperature enabling its drawing and its use by users. Hence, the more the preheated fluid 11 heats up, the less fluid 4b is consumed to ensure the set point temperature of the fluid 6. This thus makes it possible to reduce the consumption of the fluid 4b, which represents the interest of the system.

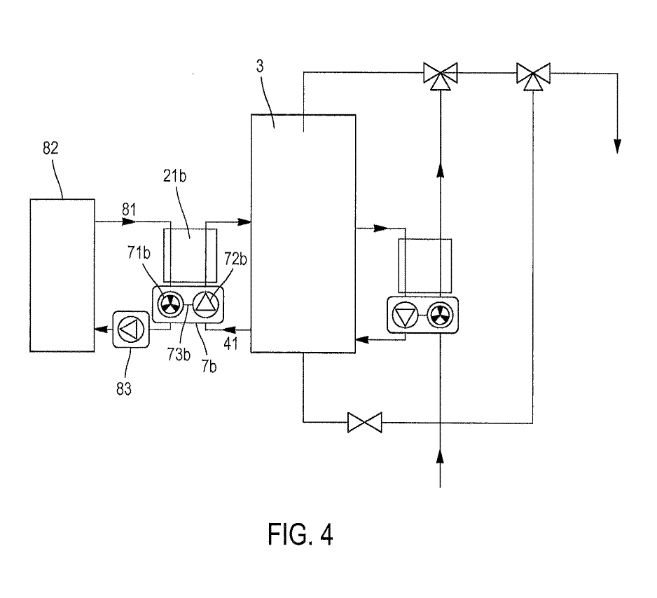

The means 5 for mixing comprises a first inlet 51 connected to the storage means 3 for receiving the receiving fluid 4b and a second inlet 52 connected to the means 21 for transferring heat for receiving the preheated working fluid 11. In the example of FIG. 3, a second thermostatic valve 54 is illustrated. The second thermostatic valve 54 makes it possible to add a level of security to the system in order to avoid that the user at the end of the line does not receive water that is too hot if the heat recovery system is very efficient, thus meeting the norms set for the production of domestic hot water. The system of FIG. 4 represents another embodiment of the invention. It is another manner of using the device 7.

According to the example of FIG. 4, the system differs from that of FIG. 3 in that it also comprises a second device 7b intercalated between the storage cylinder 3 and an energy input device 82, said device making it possible to heat the water present in the storage cylinder 3. A device 7b coupled to a circulator 83 is thus used.

In this case, it is the circulator 83 that is going to be electrically connected and is going to set in motion the turbine 71b and the circulator 72b of the device 7b. This is going to induce a circulation of the fluid 81 (which turns in loop) which, when it is set in motion, will go through the exchanger 21b and the turbine 71b thus causing a simultaneous setting in motion of the fluid 41 through the circulator 72b. The fluid 41 passes into the plate exchanger 21b where it exchanges a heat flux with the water 81 coming from the energy input device 82. The device 7b enables the setting in motion of these fluids. In the example of FIG. 4, the device 7 of FIG. 3 continues to fulfil its function as described in FIG. 3. In an alternative embodiment, not represented, it is entirely possible to envisage only using a single device 7, either as illustrated in FIG. 3 or only between the storage cylinder 3 and the energy input device 82. The interest is only using a single command that is given to the circulator 83 to make the system functional. The energy, according to this alternative embodiment, which is going to set in motion the device, comes from the circulator 83, whereas in the example of FIG. 3, the energy comes from the pressure of the working fluid 1.

An estimation of the head loss induced by the turbine on the drinking water network as a function of the power required for the circulation of water in the plate exchanger is described hereafter.

The power of the circulator is defined as the product of the flow rate multiplied by the manometric head obtained on the operating curve of the circulator:

Pcirculator(W)=Flow rate(m³/s)×ΔP_exchanger_circuit (Pa). From equation 1:

The maximum efficiency of a Kaplan turbine is comprised between 84 and 90% with a minimum flow rate that can be turbined of 30% of the maximum flow rate Qmax.

The relative efficiency of the turbine compared to the maximum efficiency is greater than 80% when the ratio of the flow rates Q/Qmax is greater than 30% and is greater than 90% when the ratio Q/Qmax is greater than 40%.

The mechanical power of the turbine is expressed as follows: Pmechanical=efficiency_turbine×P_hydraulic, where P_hydraulic=Flow rate (Q)×Hn×rho_water×g, with Hn=net available head, or head loss induced by the turbine, rho_water is the specific gravity of water, and g is the acceleration due to gravity.

Hence the expression of Hn:

$${H}_{n} = \frac{{P}_{mechanical turbine}}{{η}_{turbine} \dot{Q} {ρ}_{water} g} = \frac{{P}_{circulator}}{{η}_{circulator} {η}_{turbine} \dot{Q} {ρ}_{water} g}$$

$${H}_{n} = \frac{Δ {P}_{exchanger circuit} }{{η}_{circulator} {η}_{turbine} {ρ}_{water} g}$$

In the expression of Hₙ, ΔP_{exchanger circuit} is in general a function of the circulating flow rate. The efficiency is specific to the dimensioning of the system and relative to the flow rate to ensure an equality of the flow rate of the fluids passing through the exchanger.

Let us take the example of a private house:

Maximum DHW flow rate of 10 l/min, i.e. 0.17 kg/s or instead 600 l/h.

Exchanger: thermal power exchanged of the order of 6-10 kW with head losses less than 1 mCE i.e. 10000 Pa.

The power required at the level of the circulator is P_mech_circulator=0.17 10⁻³. 10000=1.7 W.

The hydraulic power coming from the turbine must then be P hydro_turbine=Pmech_turbine/efficiency_turbine.

Hence Hn=1.7/(0.8. 0.3 0.17 10⁻³. 10)=4.16 m of water column is equivalent to 0.4 bars of pressure drop on the water column.

Hn must correspond to the head losses generated by the turbine, this signifies that there is an additive pressure loss on the water network of 0.4 bars for a flow rate of 10 l/min and a hydraulic resistance in the plate exchanger of 10000 Pa. This result is to be compared with the head losses of the other elements of the circuit and with the pressure of the drinking water network (generally comprised between 3 and 6 bars). NB: for network pressures greater than 3.5 bars, it is in general preferable to add a pressure reducer. Consequently, as a general rule, the pressure drop generated by the turbine should not exceed 10% of the total pressure.

In this calculation, the hydraulic/mechanical conversion efficiency of the turbine is taken around 30% with regard to the specific configuration with low flow rates.

The invention is not limited to the embodiments described previously with reference to the figures and alternative embodiments could be envisaged without going beyond the scope of the invention.

1. A system for exchanging heat from a working fluid to a receiving fluid, said system comprising:
a device configured to transmit kinetic energy from a working fluid to a receiving fluid comprising:
a circulator configured to circulate the receiving fluid;
a turbine configured to be driven by the circulation of the working fluid; and
a shaft coupling the turbine to the circulator;
a heat transfer system configured to transfer heat from the working fluid by heat transfer to the receiving fluid;
a first mixing system configured to mix the receiving fluid and the heated working fluid.

2. The system according to claim 1, further comprising
a first pipe configured to circulate the working fluid and connected to the turbine;
a second pipe configured to circulate the receiving fluid and connected to the circulator.

3. The system according to claim 1, wherein the first mixing system comprises a first inlet connected to a storage system configured to store the receiving fluid and a second inlet connected to the heat transfer system configured to transfer heat from the working fluid.

4. The system according to claim 1, further comprising a second mixing system configured to mix the fluid coming out of the first mixing system and the heated working fluid.

5. The system according to claim 1, wherein the circulator comprises an outlet to be connected to a hot water storage tank.

6. The system according to claim 1, wherein the first mixing system is a thermostatic valve.

7. The system according to claim 1, wherein the heat transfer system configured to transfer heat is a plate exchanger.

8. The system according to claim 1, wherein:
the turbine comprises a first axis of rotation;
the circulator comprises a second axis of rotation co-linear with the first axis of rotation;
and wherein the shaft couples the first axis of rotation to the second axis of rotation.

9. The system according to claim 1, wherein the turbine is a propeller turbine.

10. The system according to claim 1, wherein the circulator is of centrifugal force vane type.
